(19) United States
(12) Patent Application Publication
(10) Pub. No.: US 2005/0058773 A1
(43) Pub. Date: Mar. 17, 2005

(54) Method of manufacturing micro lens, micro lens, optical device, optical transmitting device, laser printer head, and laser printer

(75) Inventors: Hironori Hasei, Okaya-shi (JP); Satoshi Kito, Suwa-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/902,175

(22) Filed: Jul. 30, 2004

(30) Foreign Application Priority Data
Aug. 6, 2003 (JP) 2003-288031

(51) Int. Cl. B05D 5/06

(52) U.S. Cl. 427/162

(57) ABSTRACT

A method of manufacturing a micro lens that can enhance the accuracy of landing positions of droplets and can fabricate a micro lens with good shape accuracy, a micro lens, an optical device, an optical transmitting device, a laser printer, head and a laser printer are provided. In a method of manufacturing a micro lens, a given number of droplets of a lens material are ejected from a droplet ejection head on a base member formed on a substrate. The method includes stopping relative movement between the substrate and the droplet ejection head; and ejecting a plurality of the droplets on a given position on the substrate from the droplet ejection head.

### BACKGROUND OF THE INVENTION

1. Field of Invention

Exemplary aspects of the present invention relate to a method of manufacturing a micro lens, a micro lens, an optical device, an optical transmitting device, a laser printer head, and a laser printer.

2. Description of Related Art

The related art includes optical devices having a large number of minute lenses referred to as micro lenses.

Examples of such optical devices include a light emitting device equipped with a laser, an optical interconnection of optical fibers, and a solid-state imaging device having a condenser lens to condense incident light.

A micro lens included in such a related art optical device can be formed by a forming process using a die and photolithography.

In addition, the related art includes a droplet ejection method employed for a printer and the like so as to form a micro lens, which requires a minute pattern. See Japanese Unexamined Patent Publication No. 11-142608 (pp. 2-3 FIG. 1).

### SUMMARY OF THE INVENTION

As described above, in a related art method of manufacturing a micro lens that employs a droplet ejection method, a plurality of droplets is ejected onto the same position while a substrate on which micro lenses are formed and a droplet ejection head are moved relative to each other, so as to fabricate one micro lens. Specifically, while moving a substrate (in a reciprocating manner) so that a head scans the substrate, one-dot droplet is ejected from the droplet ejection head each time the substrate passes beneath the droplet ejection head.

However, such a method involves a problem in that it is difficult to enhance the accuracy of landing positions of droplets since a substrate is moved relative to a droplet ejection head.

Exemplary aspects of the present invention address or solve the above and/or other problems and provide: a method of manufacturing a micro lens that can enhance the accuracy of landing positions of droplets and can fabricate a micro lens with good shape accuracy; a micro lens; an optical device; an optical transmitting device; a laser printer head; and a laser printer.

In order to address or achieve the above, a method of manufacturing a micro lens of an exemplary aspect of the present invention is provided in which a given number of droplets of a lens material are ejected from a droplet ejection head on a base member formed on a substrate. The method includes: stopping relative movement between the substrate and the droplet ejection head; and ejecting a plurality of the droplets on a given position on the substrate from the droplet ejection head.

Specifically, in the method of manufacturing a micro lens of an exemplary aspect of the present invention, the plurality of droplets is ejected in a state in which the relative movement between the substrate and the droplet ejection head is stopped. Thus, the accuracy of landing positions of the droplets can be enhanced compared to a related art method in which droplets are ejected while a substrate is moved relative to a droplet ejection head. Therefore, the shape accuracy of micro lenses can also be enhanced.

In addition, since the plurality of droplets is ejected, the number of relative movements (scan) between the substrate and the droplet ejection head until droplets of the given number are ejected, can be decreased. Thus, variation in landing positions of droplets can be suppressed, enabling the enhancement of the accuracy of landing positions.

The greater the number of the droplets that are ejected in a state in which the relative movement between the substrate and the droplet ejection head is stopped, the more easily the accuracy of landing positions of the droplets can be enhanced.

In an exemplary aspect of the present invention, the number of the droplets that are sequentially ejected from the droplet ejection head at one time may be the same as the given number.

In this configuration, the droplets of the given number are sequentially ejected at one time while the relative movement between the substrate and the droplet ejection head is kept constant. Thus, the variation in landing positions of droplets can be further suppressed, enabling further enhancement of the accuracy of landing positions.

In an exemplary aspect of the present invention, the number of droplets that are sequentially ejected from the droplet ejection head at one time may be smaller than the given number. In addition, preliminary hardening may be implemented for the lens material that has landed on the base member before the next ejection of the droplets to the same base member.

In this configuration, the lens material that has landed on the base member is preliminarily hardened. Thereafter, droplets are ejected on the base member again. By preliminarily hardening, lens material droplets of a larger amount, compared to the case in which preliminary hardening is not implemented, can be ejected on the base member without damaging the shape of the micro lens. Accordingly, a micro lens of larger size can be formed on the base member.

In an exemplary aspect of the present invention, ejection of the droplets to the same base member may be repeated while the relative movement is stopped until a total number of the droplets ejected on the same base member becomes equal to the given number.

According to this configuration, droplets are ejected onto the same base member until the sum of the number of ejected droplets becomes the given number. Therefore, a relative positional relationship between the base member and the droplet ejection head is kept constant until the ejection of droplets is completed. Thus variation in landing positions of droplets can be suppressed, enabling the enhancement of accuracy of landing positions.

In an exemplary aspect of the present invention, after the droplets are ejected on one base member, the droplets may be ejected on at least one other base member, and then the droplets may be ejected on the one base member again.

According to this configuration, since the lens material that has landed can be preliminarily hardened in parallel with ejection of droplets onto other base member, the time required to form a micro lens on the substrate can be shortened.

In an exemplary aspect of the present invention, the droplets may be ejected on a plurality of base members at one time from the droplet ejection head.

In this configuration, since droplets are ejected onto a plurality of base members simultaneously, the time required to form a micro lens on the substrate can be shortened.

In an exemplary aspect of the present invention, the lens material may be a material diluted with a volatile solvent. Furthermore, the preliminary hardening may be implemented by allowing the lens material that has landed to stand for given time.

In this configuration, by allowing the lens material that has landed to stand for given time, the solvent in the lens material is vaporized so as to increase the viscosity of the lens material. Thereby, preliminary hardening is implemented. Thus, lens material of larger amount can be ejected onto the base member without damaging the shape of micro lenses such that a micro lens with larger size can be formed.

In an exemplary aspect of the present invention, the lens material may be a material reacting to ultraviolet rays so as to be hardened. Furthermore, the preliminary hardening may be implemented by irradiating the lens material that has landed with ultraviolet rays.

In this configuration, the lens material is preliminarily hardened by irradiating the lens material that has landed with ultraviolet rays (UV). Thus, lens material of larger amount can be ejected onto the base member without damaging the shape of micro lenses such that a micro lens with larger size can be formed.

A micro lens of an exemplary aspect of the present invention is manufactured by the method of manufacturing a micro lens of an exemplary aspect of the present invention.

With respect to this micro lens, droplets can be landed on the base member more precisely since droplets are ejected while stopping the relative movement between the substrate and the droplet ejection head. Therefore a micro lens with better shape accuracy can be fabricated.

In addition, since droplets are ejected and land after the lens material that has already landed is preliminarily hardened, the amount of lens material disposed on the base member can be increased such that a micro lens with larger size can be formed.

An optical device according to an exemplary aspect of the present invention includes a surface emitting laser and a micro lens obtained through the method of manufacturing a micro lens of an exemplary aspect of the present invention, the micro lens being provided on the emitting side of the surface emitting laser.

According to the optical device, as mentioned above, since the micro lens having better shape accuracy and larger size is disposed on the emitting side of the surface emitting laser, it is possible to collimate light emitted from a light emitting laser, and so forth. Consequently, proper light emission characteristics (optical characteristics) is achieved.

An optical transmitting device according to an exemplary aspect of the present invention includes the optical device of an exemplary aspect of the present invention, a light receiving element, and a light transmission device to transmit light emitted from the optical device to the light receiving element.

According to the optical transmitting device, since it has an optical device having the proper light emitting characteristics (optical characteristics) as mentioned above, it becomes an optical transmitting device having the proper transmission characteristics.

A laser printer head according to an exemplary aspect of the present invention includes the optical device of an exemplary aspect of the present invention.

According to the laser printer head, since it has an optical device having the proper light emitting characteristic (optical characteristic) as mentioned above, it becomes a proper laser printer head having proper drawing characteristics.

A laser printer according to an exemplary aspect of the present invention includes the laser printer head of an exemplary aspect of the present invention.

According to the laser printer, since it has a laser printer head having the proper drawing characteristics as mentioned above, the laser printer itself excels in drawing characteristics.

### BRIEF DESCRIPTION OF THE DRAWINGS

FIG. 1 is a schematic showing a process flow chart of a first embodiment;

FIGS. 2a through 2e are schematics of manufacturing processes of a micro lens of the first exemplary embodiment;

FIGS. 3a and 3b are schematics of a droplet ejection head of the first exemplary embodiment;

FIGS. 4a and 4b are schematics of manufacturing processes of the micro lens of the first exemplary embodiment;

FIGS. 5a through 5c are schematics showing the micro lens of the first exemplary embodiment;

FIGS. 6a through 6c are schematics showing a function of a micro lens for collimating light;

FIG. 7 is a schematic for explaining a contact angle of a lens material that is obtained by lyophobic treatment;

FIG. 8 is a schematic of a laser printer head of an exemplary aspect of the present invention;

FIG. 9 is a schematic showing a process flow chart of a second exemplary embodiment;

FIGS. 10a and 10b are schematics of manufacturing processes of a micro lens of the second exemplary embodiment; and

FIG. 11 is a schematic showing a process flow chart of a modification of the second exemplary embodiment.

### DETAILED DESCRIPTION OF EXEMPLARY EMBODIMENTS

### First Exemplary Embodiment

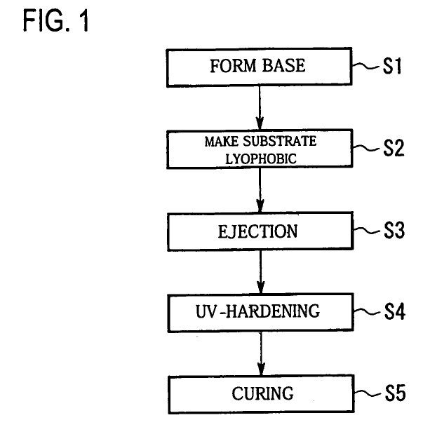

A first exemplary embodiment of the present invention will now be described below with reference to FIGS. 1 through 8.

FIG. 1 is a schematic showing a process flow chart of a method of manufacturing a micro lens of the present exemplary embodiment.

First, a method of manufacturing a micro lens of the present exemplary embodiment will be described. As shown in FIG. 1, a method of manufacturing a micro lens includes a base forming process (S1) in which a base member is formed on a substrate, and a process for making the substrate lyophobic (S2) in which lyophobic treatment is implemented for an upper surface of the base member. The method also includes an ejection process (S3) in which multiple dots of a lens material are ejected on the upper surface of the lyophobicity-treated base member by a droplet ejection method so as to form micro lenses on the base member, a UV (ultraviolet rays)-hardening process (S4) in which a lens material is irradiated with UV so as to be hardened, and a curing process (S5) in which heat treatment is implemented for the hardened micro lens.

Here, “substrate” indicates an element that has a surface on which the base member can be formed. Specifically, it is a glass substrate, a semiconductor substrate, and further these substrates including various functional thin films and functional elements formed thereon. As for the surface on which the base member can be formed, it may be a planar or curved surface. Furthermore, the shape of the substrate itself is not limited to any particular shape but applies various shapes.

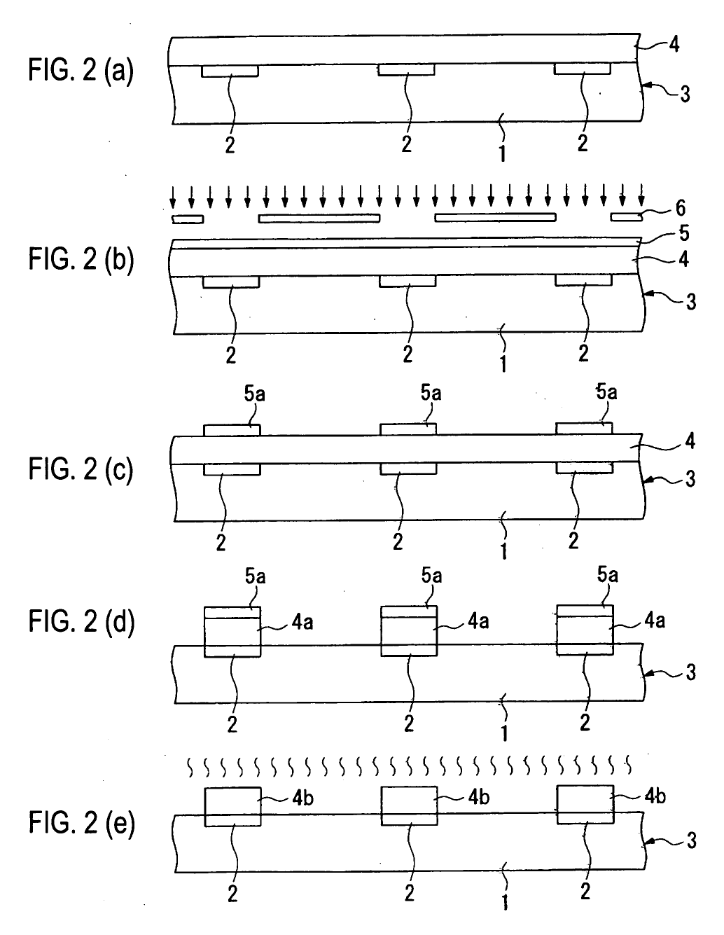

In the present exemplary embodiment of the invention, as shown in FIG. 2a, a GaAs substrate 1 is used, and a substrate obtained by forming a number of surface emitting lasers 2 on the GaAs substrate 1 is prepared as a substrate 3. Then, on the upper surface side of the substrate 3, specifically, on the surface that is on the emitting side of the surface emitting lasers 2, the forming material of the base member is provided so as to form a base member material layer 4. In the vicinity of an emitting port of the surface emitting lasers 2, an insulating layer (not shown) made up of polyimide resin and the like is formed. As the forming material of the base member, a material having optical transparency, specifically, a material hardly absorbing light in a wavelength region of light emitted from the surface emitting lasers 2, and hence allowing the emitted light to virtually pass through may be used. For example, polyimide resin, acryl resin, epoxy resin, or fluoride resin is suitably used. The polyimide resin is more suitably used.

The base forming process (S1) will be described first.

In the present exemplary embodiment, polyimide resin is used as a forming material of a base member. The precursor of this polyimide resin is applied on the substrate 3. Then, the precursor is heated at about 150 degrees centigrade, and thereby the precursor is turned into the base member material layer 4 shown in FIG. 2a. In this stage, the base member material layer 4 is not hardened fully but hardened to an extent sufficient to maintain the shape thereof, at most.

After the base member material layer 4 made up of the polyimide resin is thus formed, a resist layer 5 is formed on this base member material layer 4 as shown in FIG. 2b. Then, the resist layer 5 is subjected to exposure by using a mask 6 in which a given pattern is formed, and further to development, and thereby resist patterns 5a are formed as shown in FIG. 2c.

Next, with the resist patterns 5a as a mask, for example, by wet etching using an alkali solution, the base member material layer 4 is patterned. Thus, base member patterns 4a are formed on the substrate 3 as shown in FIG. 2d. As for the base member patterns 4a to be formed, the upper surface shape thereof may be a circular, elliptic, or polygonal in terms of forming a micro lens thereon. In the present exemplary embodiment, the upper surface is circular. Furthermore, it is formed so that the center position of the upper surface of such circular shape is placed directly above an emitting port (not shown) of the surface emitting lasers 2 formed on the substrate 3.

Thereafter, as shown in FIG. 2e, the photoresist patterns 5a are removed, and heat treatment at 350 degrees centigrade is performed. Thereby the base member patterns 4a are sufficiently hardened so as to form base members 4b.

Next, the process for making substrate lyophobic (S2) to implement lyophobic treatment for the upper surface of the base member 4b will be described.

As a method of lyophobic treatment, for example, a method of forming a self-assembled film on the surface of a substrate, a plasma treatment method, and so forth can be adopted.

In a self-assembled film forming method, a self-assembled film including an organic molecular film and so forth is formed on the surface of a substrate on which a conductive film wire is to be formed.

The organic molecular film to treat the surface of a substrate is equipped with a functional group that can bond with a substrate, a functional group that modifies the properties of the surface (controls the surface energy), such as a lyophilic group or a lyophobic group on the opposite side of the functional group bonding with a substrate, and a normal carbon chain or a partially branched carbon chain that interconnects these functional groups. The organic molecular film bonds with a substrate and self-assembles to form a molecular film, such as a monomolecular film.

The self-assembled film includes a bonding functional group that can react with atoms constituting the foundation layer of a substrate and a normal chain molecule other than the bonding functional group. The self-assembled film is formed by orientating a compound having an extremely high orientation due to the interaction of the normal chain molecules. Since a self-assembled film is formed by orientating single molecules, the film can be extremely thin and can be uniform at the molecular level. Since the same molecules are disposed on the surface of a film, it is possible to apply uniform and excellent lyophilicity or lyophobicity to the surface of the film.

By using, for example, fluoroalkylsilane as the above compound having high orientation, each compound is orientated so that the fluoroalkyl group is positioned on the surface of a film, so as to form a self-assembled film. Thus uniform lyophobicity is applied to the surface of the film.

As chemical compounds for forming a self-assembled film, fluoroalkylsilane (hereinafter “FAS”), such as: heptadecafluoro-1,1,2,2 tetrahydrodecyltriethoxysilane; heptadecafluoro-1,1,2,2 tetrahydrodecyltrimethoxysilane; heptadecafluoro-1,1,2,2 tetrahydrodecyltrichlorosilane; tridecafluoro-1,1,2,2 tetrahydrooctyltriethoxysilane; tridecafluoro-1,1,2,2 tetrahydrooctyltrimethoxysilane; tridecafluoro-1,1,2,2 tetrahydrooctyltrichlorosilane; and trifluoropropyltrimethoxysilane can be exemplified. These compounds can be used alone or in combination.

By using FAS, adhesiveness with a substrate as well as good lyophobicity can be obtained.

FAS can commonly be expressed by the following structural formula: RnSiX₍₄₋ₙ₎. In the formula, n denotes an integer number from 1 to 3, X denotes hydrolytic groups, such as a methoxy group, an ethoxy group, and a halogen atom. Meanwhile, R denotes a fluoroalkyl group having the following structure: (CF₃)(CF₂)x(CH₂)y where x denotes an integer number from 0 to 10, y denotes an integer number from 0 to 4. If a plurality of R or X is bonded with Si, the R or the X can be the same or different from each other. The hydrolytic group denoted by X forms silanol when hydrolyzed so as to react with a hydroxyl group of the foundation layer of a substrate (glass, silicon), and thus is bonded with the substrate by the siloxane bond. Meanwhile, since R has a fluoro group, such as (CF₂) on the surface, R modifies the surface of the foundation layer of a substrate to be a non-wetting (with a low surface energy) surface.

A self-assembled film including an organic molecular film and so forth is formed on a substrate by sealing the above material compound and the substrate in a airtight container and keeping it at room temperature for two or three days. If the container is held at 100 degrees centigrade, a film is formed in about three hours. In these methods, a film is formed from the vapor phase. In addition, a self-assembled film can also be formed from the liquid phase. For example, a self-assembled film can also be formed on a substrate by dipping the substrate into a solution containing a material compound, and then washing and drying the substrate.

Before forming a self-assembled film, pre-treatment for the substrate surface may be implemented by irradiating the substrate surface with ultraviolet light, or washing it with a solvent.

As the plasma method, for example, a CF₄ plasma treatment method that uses tetrafluoromethane as process gas in the atmosphere is suitably employed. Conditions for this CF₄ plasma treatment are, for example, a plasma power of 50 to 1000 kW, a tetrafluoromethane (CF₄) gas flow rate of 50 to 100 ml/min, a conveying speed of the substrate 3 relative to a plasma discharge electrode of 0.5 to 1020 mm/sec, and a substrate temperature of 70 to 90 degrees centigrade. The process gas is not limited to tetrafluoromethane (CF₄), while other fluorocarbon gases may be used. By performing such lyophobic treatment, a fluorine radical is introduced into resin that constitutes the upper surface of the base member 4b, thereby providing high lyophobicity.

Such lyophobic treatment may be implemented in a manner of obtaining such lyophobicity that, especially when arranging the lens material to be described on the plane formed with the forming material of the base member 4b, the contact angle of the lens material is 20 degrees or more.

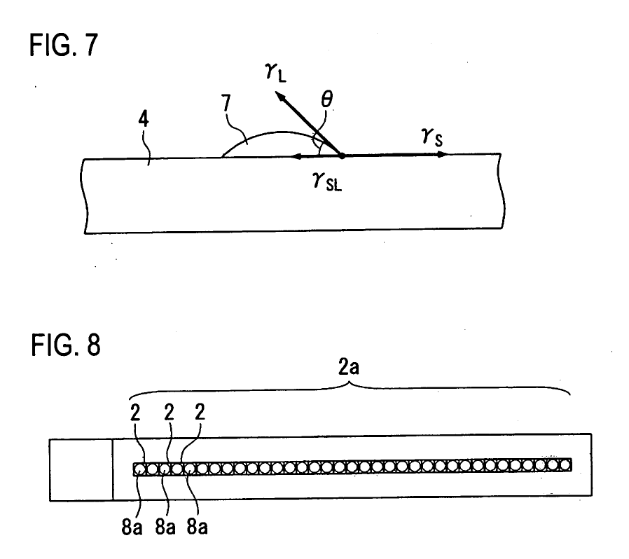

Specifically, as shown in FIG. 7, the base member material layer 4 is formed of a forming material (polyimide resin in this example) of the base member 4b, and its surface is set flat. Then, for this surface, the above-mentioned lyophobic treatment is applied. Next, onto this surface, the lens material 7 is deposited by the droplet ejection method.

Then, the lens material 7 becomes a droplet of a shape corresponding to the wettability with respect to the surface of the base member material layer 4. At this time, if the surface tension of the base member material layer 4 is γ_{S}, the surface tension of the lens material 7 is γ_{L}, the interfacial tension between the base member material layer 4 and the lens material 7 is γ_{SL}, and the contact angle of the lens material 7 with respect to the base member material layer 4 is θ, the following formula is satisfied among γ_{S}, γ_{L}, γ_{SL}, and θ
γ_{S}=γ_{SL}+γ_{L}·COS θ

The curvature of the lens material 7 that becomes a micro lens as described later is restricted by the contact angle θ determined by the foregoing formula. Specifically, the curvature of a lens obtained after hardening the lens material 7 is one of elements that determine the final shape of the micro lens. Consequently, in an exemplary aspect of the present invention, contact angle θ may be increased, that is, make θ be 20 degrees or more by increasing the interfacial tension γ_{SL} between the base member material layer 4 and the lens material 7 through the lyophobic treatment so that the shape of the obtained micro lens may be closer to a spherical shape.

In this manner, by implementing such lyophobic treatment that the contact angle θ, shown in FIG. 7, becomes 20 degrees or more for the upper surface of the base member 4b, there is an increase in the contact angle θ′ of the lens material 7, which is ejected and deposited on the upper surface of the base member 4b as described later, with respect to the upper surface of the base member 4b. Consequently, the amount of the lens material to be placed on the upper surface of the base member 4b can be further increased, thus making it easy to control its shape by the ejection amount (amount of ejected dots).

Next, the ejection process (S3) will be described.

After lyophobic treatment is thus implemented for the upper surface of the base member 4b, a plurality of dots of the lens material 7 are ejected onto the base member 4b by a droplet ejection method. As the droplet ejection method, a dispenser method, an inkjet method and so forth may be adopted. The dispenser method is a typical related art method of ejecting droplets, and is effective in ejecting droplets over a relatively wide region. The inkjet method is a method of ejecting droplets by using an inkjet head, and is capable of controlling a droplet ejecting position by a unit of μm order. Moreover, the amount of droplet to be ejected can be controlled by a unit of pico liter order, such that this method is suited particularly to the fabrication of minute lenses (micro lenses).

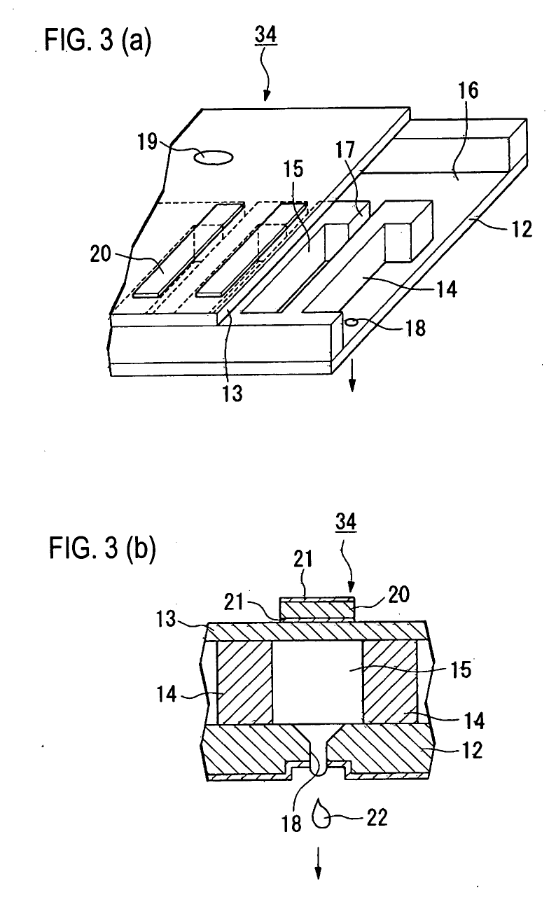

Now, in the present exemplary embodiment, the inkjet method will be used as the droplet ejection method. In this inkjet method, as an inkjet head 34, a head that includes a nozzle plate 12 of stainless steel and a diaphragm 13 that are jointed to each other through a partition member (reservoir plate) 14, as shown in FIG. 3a, is used. Between the nozzle plate 12 and the diaphragm 13, a plurality of cavities 15 and a reservoir 16 are formed by the partition member 14. The cavities 15 and the reservoir 16 communicate with each other through a flow channel 17 therebetween.

The insides of each cavity 15 and the reservoir 16 are filled with liquid (lens material) for ejection, and the flow channel 17 therebetween functions as a supply port to supply the liquid from the reservoir 16 to the cavity 15. In the nozzle plate 12, a plurality of nozzles 18 to eject the liquid from the cavity 15 are formed in a manner to be arrayed longitudinally and transversely. A hole 19 leading to the reservoir 16 is formed in the diaphragm 13, and a liquid tank (not shown) is coupled to the hole 19 through a tube (not shown).

Onto a surface of the diaphragm 13 on an opposite side of a surface facing the cavity 15, a piezoelectric element (a piezo element) is joined as shown in FIG. 3b. The piezoelectric element 20 is interposed between a couple of electrodes 21 so as to be bent in a manner of protruding outside through energization, and functions as an ejection device in the present exemplary embodiment invention.

The diaphragm 13 to which the piezoelectric element 20 is joined under such a structure is bent outward integrally and simultaneously with the piezoelectric element 20, and thereby increasing the volume of the cavity 15. Then, in the case in which the cavity 15 communicates with the reservoir 16 and the reservoir 16 is filled with liquid, liquid of an amount corresponding to the increased volume in the cavity 15 flows from the reservoir 16 via the flow channel 17.

Then, when energization for the piezoelectric element 20 is removed in such a state, the piezoelectric element 20 and the diaphragm 13 revert to their original shapes. Hence, since the cavity 15 also reverts to its original volume, pressure of the liquid inside the cavity 15 rises so as to eject a liquid droplet 22 from the nozzle 18.

As an ejection device of the droplet ejection head, a device other than an electromechanical transducer using the piezoelectric element (a piezo element) 20 may be available. For example, a method in which an electrothermal transducer is used as an energy generating element, continuous methods, such as a charge control type and a pressure vibration type, an electrostatic suction method, and a method in which a electromagnetic wave, such as a laser is emitted, to generate heat so as to eject liquid by utilizing the operation of the heat generation, may be adopted.

As the lens material 7 to be ejected, specifically the lens material 7 that becomes the micro lens, optical transparent resin is used. Specifically, acryl resin, such as polymethyl methacrylate, polyhydroxyethyl methacrylate, and polycyclohexyl methacrylate, allyl resin, such as polydiethyleneglycolbisaryl carbonate, and polycarbonate, methacrylic resin, polyurethane resin, polyester resin, polyvinylchloride resin, polyvinylacetate resin, cellulose resin, polyamide resin, fluororesin, polypropylene resin, polystyrene resin, and other thermoplastic or heat curing resins may be used. Of these, one kind may be used, or a plurality of kinds may be mixed and used.

The surface tension of the optical transparent resin used as the lens material 7 may be within a range from 0.02 N/m to 0.07 N/m. When ejecting ink by the droplet ejection method, if the surface tension is less than 0.02 N/m, the ink's wettability with respect to a nozzle surface increases, such that flying deviation tends to occur. If the surface tension exceeds 0.07 N/m, the shape of a meniscus at the nozzle tip becomes unstable, thus making it difficult to control the ejection amount and ejection timing. To adjust the surface tension, a minute amount of a surface tension regulator, such as a fluorine type, a silicone type and a nonionic type, may be added to the dispersion liquid of the optical transparent resin to an extent that there is no appreciable drop of its contact angle with respect to the substrate and optical characteristics, such as refractive index, are not affected. The nonionic surface tension regulator enhances the wettability of an ink with respect to a substrate, enhances the leveling property of a film, and serves to prevent minute concavities and convexity of a film from being generated. The surface tension regulator may include, as necessary, organic compounds, such as alcohol, ether, ester, and ketone.

The viscosity of the optical transparent resin used as the lens material 7 may be within a range from 1 mPa.s to 200 mPa.s. When ejecting ink by the droplet ejection method, if the viscosity is less than 1 mPa.s, the periphery of the nozzle tends to be soiled because of an outflow of the ink. If the viscosity exceeds 50 mPa.s, ejection is made possible by setting up an ink heating mechanism at the head or the droplet ejection device. However in normal temperature, the frequency of clogging nozzle holes increases, thus making it difficult to eject droplets smoothly. In the case of over 200 mPa.s, it is difficult to drop viscosity to a level of ejecting droplets even by heating.

Furthermore, in an exemplary aspect of the present invention, as the optical transparent resin, especially resin that is non-solvent type, may be used. The optical transparent resin of the non-solvent type is turned into liquid not by being dissolved with an organic solvent but instead by, for example, being diluted with its monomer, thus enabling ejection from the droplet ejection head 34. Furthermore, this optical transparent resin of the non-solvent type can be used as resin of a radiation curing type by blending a photopolymerization initiator, such as a biimidazole compound therewith. Specifically, by blending such photopolymerization initiator therewith, the radiation curing property may be provided to the optical transparent resin. Here, radiation is the generic term of a visible ray, an ultraviolet ray, a far ultraviolet ray, an X-ray, an electronic ray and the like. Particularly, the ultraviolet ray is generally used.

The optical transparent resin is not limited to a non-solvent type. The optical transparent resin of a solvent type can also be used.

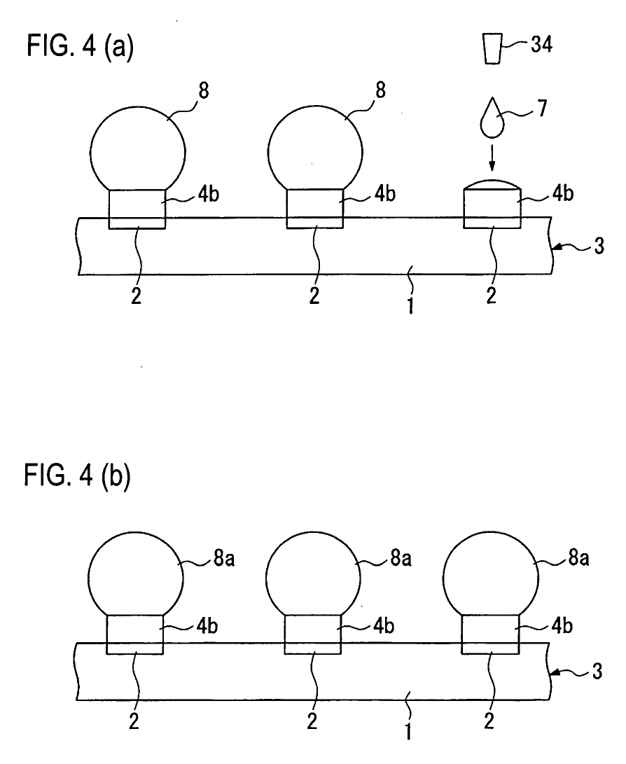

A plurality of dots of such lens material 7 is ejected onto the base member 4b with the droplet ejection head 34 having the above structure as shown in FIG. 4a, so as to form the micro lens precursor 8 on the base member 4b.

In the ejection, the base member 4b stops beneath the droplet ejection head 34, and lens materials of the amount required to form the micro lens 8a (for example, 20 dots) are sequentially ejected at one time from the droplet ejection head 34. When the lens material 7 of 20 dots has been ejected on one base member 4b, the base member 4b moves such that the base member 4b on which the lens material 7 is not disposed is set beneath the droplet ejection head 34, and then the lens material 7 of 20 dots is ejected.

Here, by adjusting the angle of the droplet ejection head 34 with respect to the advancing direction of the base member 4b so as to make the pitch of the nozzles 18 be substantially the same as that of the base member 4b, the lens material 7 may be ejected from a plurality of nozzles 18 onto a plurality of base members 4b simultaneously. If the lens material 7 can thus be ejected on a plurality of base members 4b, a plurality of micro lenses can be formed simultaneously. Therefore, the time required to form a plurality of micro lenses can be shortened.

In addition, since the upper surface of the base member 4b is lyophobicity-treated as described above, the ejected droplet of the lens material 7 shows a reduced tendency to get wet and spread on the upper surface of the base member 4b. Therefore, the lens material 7 placed on the base member 4b does not spill over from the base member 4b but is held on the base member 4b in a stable condition.

Moreover, since 20 dots are sequentially ejected at one time, in the micro lens precursor 8 composed of the ejected lens material 7, the transverse section (a horizontal plane parallel to the upper surface of the base member 4b) becomes larger than the upper surface of the base member 4b finally.

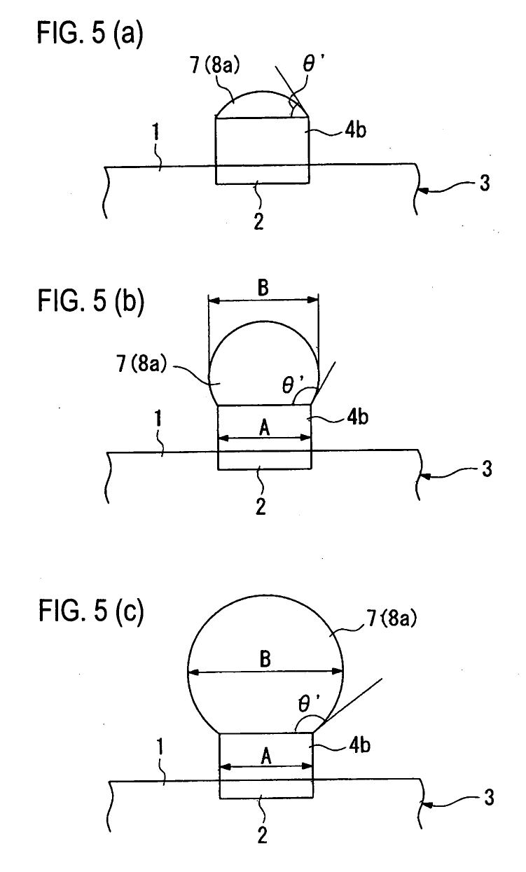

Specifically, in the beginning of ejection of the lens material 7, the ejected amount of the lens material 7 is small. Therefore, a large bump of liquid is not generated as a whole under the condition in which the liquid spreads over the entire upper surface of the base member 4b as shown in FIG. 5a, such that the contact angle θ′ with respect to the upper surface of the base member 4b is an acute angle.

If ejection of the lens material 7 is further continued from this condition, since the lens material 7 ejected later has naturally high adhesion to the lens material 7 ejected previously, it does not spill over but is held in one integral unit as shown in FIG. 5b. Then, this integrated lens material 7 increases in volume so as to swell, thus causing the contact angle θ′ with respect to the upper surface of the base member 4b to increase and finally surpass the right angle.

If the ejection of the lens material 7 is further continued from this state, since the amount of each dot is not large because of ejection by the ink jet method, the total balance of the material on the base member 4b is maintained. Thus, the contact angle θ′ becomes a large obtuse angle as shown in FIG. 5c, such that the material approaches a sphere as a result.

Next, the UV-hardening process (S4) will be described.

After the micro lens precursor 8 of a desired shape (in the present exemplary embodiment, a shape close to spherical shape as shown in FIG. 5c) is thus formed, the micro lens precursor 8 is hardened as shown in FIG. 4b so as to form the micro lens 8a. As the hardening treatment for the micro lens precursor 8, a treatment method by ultraviolet rays (wavelength λ=365 nm) irradiation may be used especially since a material to which an organic solvent is not added and that has radiation curing property is used as the lens material 7 as described above.

The curing process (S5) will now be described.

Heat treatment may be carried out, for example, at 100 degrees centigrade for about 1 hour after such hardening treatment through irradiation of ultraviolet ray. By carrying out such heat treatment, even if hardening unevenness occurs at the stage of hardening treatment through irradiation of ultraviolet ray, it is possible to decrease the hardening unevenness so as to bring about the substantially uniform degree of hardening as a whole.

After the micro lens 8a is thus formed, by cutting the substrate 3 if needed so as to form discrete pieces or an array, a micro lens of desired form is fabricated.

The optical device, which is one exemplary embodiment of the present invention, can be obtained from the micro lens 8a thus manufactured and the surface emitting laser 2 that is previously formed on the substrate 3.

In a method of manufacturing the micro lens 8a, the lens material 7 of 20 dots are sequentially ejected at one time in a state in which the base member 4b stops relatively to the droplet ejection head 34. Therefore, the lens material 7 can be disposed on substantially center part of the base member 4b accurately. Specifically, the accuracy of landing positions can be enhanced.

Furthermore, since the upper surface of the base member 4b is lyophobicity-treated, the contact angle θ′ of the lens material 7 that has been ejected and deposited with respect to the upper surface of the base member 4b can be increased. Thereby, the amount of lens material 7 to be placed on the upper surface of the base member 4b can be increased.

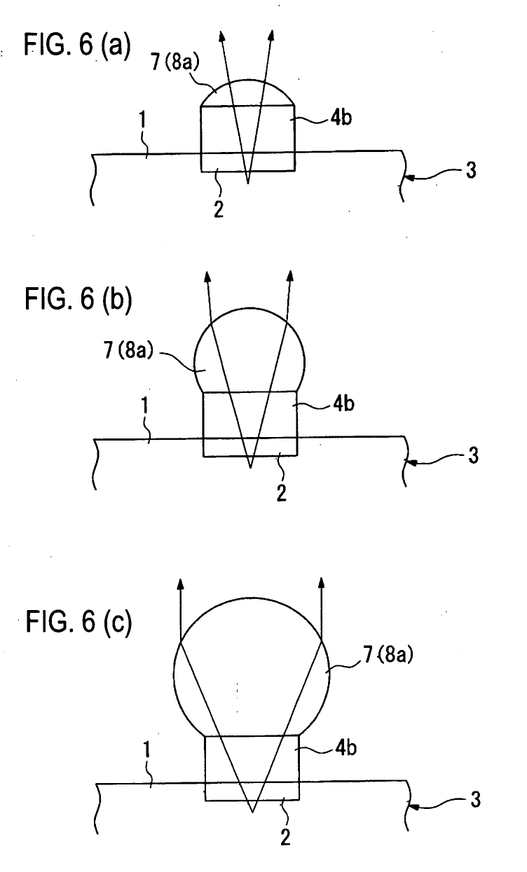

Specifically, the size of the micro lens 8a can be increased. As shown in FIGS. 6a through 6c, if the size of the micro lens 8a is increased, the focus point at the curved surface corresponding to a lens on the upper surface side approaches the emitting surface of the surface emitting laser 2 formed on the substrate 3. As the focus point approaches the emitting surface, light emitted from the upper surface side of the micro lens 8a can be more parallel light.

Conversely, in the case in which light from a light source, such as the surface emitting laser 2 does not have a radioactive property but instead has a straight traveling property, it is possible to endow transmitting light with a radioactive property by permitting it to pass through the micro lens 8a.

Furthermore, in an optical device that includes the micro lens 8a thus manufactured and the surface emitting laser 2 formed on the substrate 3, the micro lens 8a whose size and shape are properly controlled is provided on the emitting side of the surface emitting laser 2 as described above. Therefore, light emitted from the surface emitting laser 2 can be appropriately collimated by the micro lens 8a such that the optical device has proper light emitting characteristics (optical characteristics).

In the above exemplary embodiment, the base member material layer 4 is formed on the substrate 3 so as to form the base member 4b from the base member material layer 4. The present invention is not limited thereto. For example, in the case in which the surface part of the substrate 3 is formed of a transparent material, the base member may be formed in this surface part directly.

Also, as for the forming method of the base member 4b, it is not limited to photolithography. Other forming methods, for example, a selective growth method, a transfer method and so forth may be employed.

For the shape of upper surface of the base member 4b, it is possible to make various shapes, such as a triangle and a square, according to the required characteristics of a micro lens to be formed. Furthermore, for the shape of the base member 4b itself, it is possible to make various shapes, such as a tapered type and a reverse tapered type.

Moreover, in the above exemplary embodiment, the micro lens 8a is used as a lens while it remains on the base member 4b, so as to function as a micro lens. The present invention is not limited thereto. The micro lens 8a may be separated from or peeled off the base member 4b by a given method so as to be used as an independent optical part. In this case, the base member 4b to be used for fabrication does not have to be transparent.

Furthermore, in an exemplary aspect of the present invention, for the optical device including the surface emitting laser 2 and the micro lens 8a, an optical transmission device made up of an optical fiber, an optical waveguide, and so forth, that transmit light emitted from the optical device, and a light receiving element that receives the light transmitted by this optical transmission device, are provided. Thereby the device can function as an optical transmitting device.

Since such an optical transmitting device is equipped with the optical device having proper light emitting characteristics (optical characteristics) as described above, this optical transmitting device also has proper transmission characteristics.

A laser printer head according to an exemplary aspect of the present invention is provided with the above optical device. Specifically, as shown in FIG. 8, the optical device used for this laser printer head includes a surface emitting laser array 2a in which a number of surface emitting lasers 2 are arranged in a straight line, and the micro lenses 8a disposed for each of the surface emitting lasers 2 constituting this surface emitting laser array 2a. A drive element (not shown), such as a TFT, is provided for the surface emitting laser 2. A temperature compensation circuit (not shown) is provided in this laser printer head.

Furthermore, a laser printer according to an exemplary aspect of the present invention is constituted with the provision of the laser printer head of such configuration.

As far as such laser printer head is concerned, since it is equipped with the optical device having proper light emitting characteristics (optical characteristics) as mentioned above, it is a laser printer head with excellent drawing characteristics.

Furthermore, as far as a laser printer equipped with this laser printer head is concerned, since it is equipped with a laser printer head with excellent drawing characteristics as mentioned above, the laser printer itself excels in drawing characteristics.

### Second Exemplary Embodiment

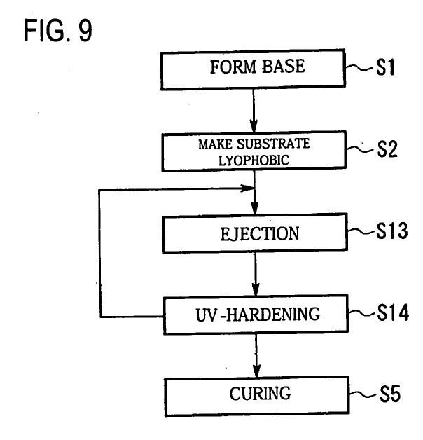

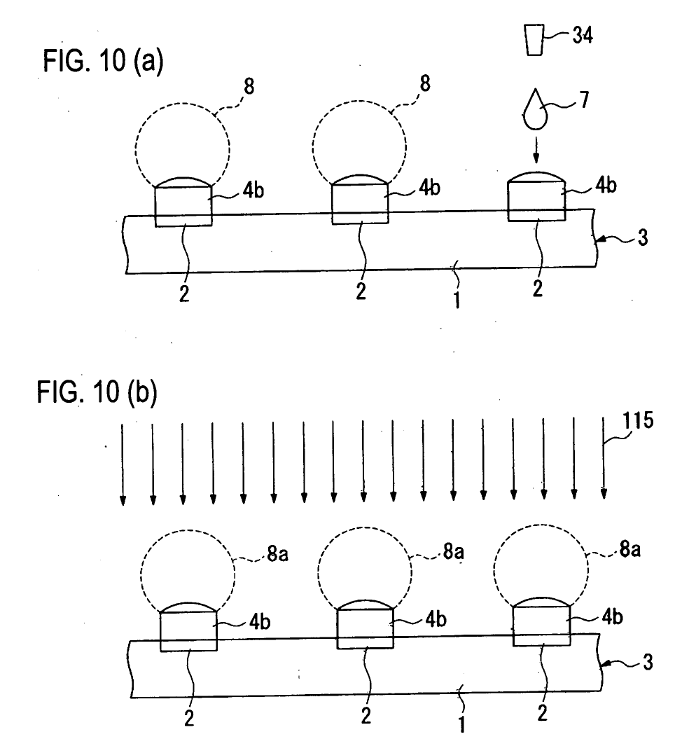

Next, a second exemplary embodiment of the present invention will now be described referring to FIGS. 9 and 10.

The method of manufacturing a micro lens of the present exemplary embodiment is substantially same as that of the first exemplary embodiment. However, the process in which a lens material is ejected is different from that of the first exemplary embodiment. Therefore, in the present exemplary embodiment, only the process of ejecting a lens material will be descried and the explanation for the base forming process and so forth will be omitted.

FIG. 9 is a schematic showing a process flow chart of a method of manufacturing a micro lens of the present exemplary embodiment.

First, the method of manufacturing a micro lens of the present exemplary embodiment will now be described. As shown in FIG. 9, a method of manufacturing a micro lens of an exemplary embodiment of the present invention includes the base forming process (S1) in which a base member is formed on a substrate, and the process for making substrate lyophobic (S2) in which lyophobic treatment is implemented for the upper surface of the base member. The method also includes an ejection process (S13) in which multiple dots of a lens material are ejected on the upper surface of the lyophobicity-treated base member by a droplet ejection method so as to form micro lenses on the base member, a UV-hardening process (S14) in which a lens material is irradiated with UV so as to be hardened, and the curing process (S5) in which heat treatment is implemented for the hardened micro lens.

Since the base forming process (S1), the process for making substrate lyophobic (S2), and the curing process (S5) are the same processes as those of the first exemplary embodiment, the description thereof will be omitted with only illustrating them in FIG. 9.

Thus, the ejection process (S13) will be described first.

FIG. 10 is a schematic of a manufacturing process of a micro lens in the present exemplary embodiment.

After lyophobic treatment is implemented for the upper surface of the base member 4b, multiple dots of the lens material 7 are ejected on the base member 4b with the droplet ejection head 34 having the above structure as shown in FIG. 10a, first. For example, 20 dots (the amount of lens material that is required for the micro lens 8a to be formed is 100 dots) are sequentially ejected at one time so as to form the micro lens precursor 8 on the base member 4b. In ejecting the lens material 7, the base member 4b stops relative to the droplet ejection head 34.

Next, the UV-hardening process (S14) will be described.

After the lens material 7 of 20 dots is ejected so as to form the micro lens precursor 8, the micro lens precursor 8 is preliminarily hardened as shown in FIG. 10b. It is sufficient that the micro lens precursor 8 is hardened to an extent that the lens material 7 has such viscosity that the micro lens precursor 8 does not crumble from the base member 4b with the collapse of the shape even when the lens material 7 lands on the micro lens precursor 8 that has been preliminarily hardened.

As the preliminary hardening treatment for the micro lens precursor 8, a treatment method by ultraviolet ray (wavelength λ=365 nm) irradiation may be used since a material, to which an organic solvent is not added and that has radiation curing property, is used as the lens material 7 as described above.

When preliminary hardening of the micro lens precursor 8 is completed, returning to the ejection process (S13) again, the lens material 7 of 20 dots is ejected on the micro lens precursor 8 that has been preliminarily hardened. Thereafter, preliminary hardening in the UV-hardening process (S14) is implemented. This cycle is repeated until the micro lens precursor 8 made up of a lens material of 100 dots is formed on the base member 4b (in the present exemplary embodiment, repeated 5 times).

Although the example in which a micro lens of 100 dots is fabricated has been described in the present exemplary embodiment, the present invention is not limited to a method of manufacturing a micro lens of 100 dots but may be used in a method of manufacturing a micro lens of more or less dots. Moreover, the number of dots of the lens material 7 that are ejected in one ejection process (S13) may be other than 20. However, such number of dots that the shape of formed micro lens precursor 8 does not collapse is preferable.

In addition, these processes may be implemented in such a manner that the relative positional relationship between the base member 4b and the droplet ejection head is kept constant until one micro lens is completed on one base member 4b, or in such a manner that a lens material is ejected on other base member 4b during the UV-hardening process (S14).

If the above processes are implemented in such a manner that the relative positional relationship between the base member 4b and the droplet ejection head is kept constant until one micro lens is completed on one base member 4b, the variation in landing positions of the lens material 7 can be suppressed until micro lenses are completed such that micro lenses with good shape accuracy can be fabricated.

Alternatively, if the lens material 7 is ejected on other base member 4b during the UV-hardening process (S14), the ejection process (S13) for the lens material 7 and the UV-hardening process (S14) can be implemented in parallel such that the time required for forming micro lenses can be shortened.

In the above configuration, after the lens material 7 that has landed on the base member 4b is preliminarily hardened, the lens material 7 is ejected on the preliminarily hardened lens material again. By preliminarily hardening the lens material 7 that has landed, a large number of droplets of a lens material can be ejected onto the base member 4b without spoiling the shape of micro lenses. Accordingly, a micro lens of larger size can be formed on the base member 4b.

Specifically, even if a micro lens to be formed is so large as to require lens materials of so large an amount that the lens material 7 crumbles from the base member 4b unless preliminary hardening is implemented, a micro lens of an accurate spherical shape can be formed.

Furthermore, since UV is used for preliminary hardening of the lens material 7, the preliminary hardening can be implemented at a given timing so that the lens material 7 has a given viscosity. Thus, the time to fabricate micro lenses can be shortened, while micro lenses with good shape accuracy can be formed.

Here, it should be understood that the scope of the present invention is not limited to the above exemplary embodiments but may be applied to various kinds of modifications without departing from the scope and spirit of the present invention.

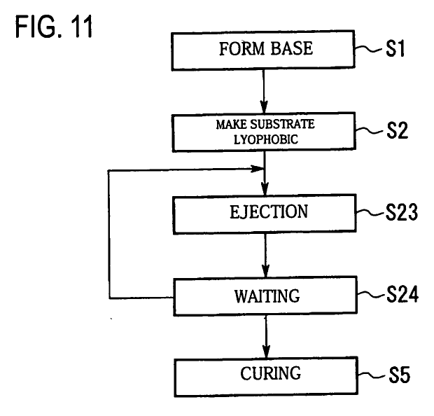

Next, a modification of a second exemplary embodiment of the present invention will now be described referring to FIG. 11.

The method of manufacturing a micro lens of the present exemplary embodiment is substantially same as that of the first exemplary embodiment. However, the process in which a lens material is ejected is different from that of the first exemplary embodiment. Therefore, in the present exemplary embodiment, only the process of ejecting a lens material will be described and the explanation for the base forming process and so forth will be omitted.

FIG. 11 is a schematic showing a process flow chart of a method of manufacturing a micro lens of the present exemplary embodiment.

First, the method of manufacturing a micro lens of the present exemplary embodiment will now be described. As shown in FIG. 11, this method of manufacturing a micro lens includes the base forming process (S1) in which a base member is formed on a substrate, and the process to make substrate lyophobic (S2) in which lyophobic treatment is implemented for the upper surface of the base member. The method also includes an ejection process (S23) in which multiple dots of a lens material are ejected on the upper surface of the lyophobicity-treated base member by a droplet ejection method so as to form micro lenses on the base member, a waiting process (S24) in which the landed lens material is allowed to stand so as to be preliminarily hardened, and the curing process (S5) in which heat treatment is implemented for the hardened micro lens.

Since the base forming process (S1), the process to make substrate lyophobic (S2), and the curing process (S5) are the same processes as those of the first exemplary embodiment, the description thereof will be omitted with only illustrating them in FIG. 11.

Thus, the ejection process (S23) will be described first.

Although the ejection process (S23) of the present modification is substantially same as the ejection process (S13) of the second exemplary embodiment, there is a difference in the lens material 7 to be used. In the second exemplary embodiment, the lens material 7 that is a non-solvent type may preferably be used. However, the lens material 7 that is a solvent type may preferably be used in the present modification.

Therefore, since the modification is the same as the second exemplary embodiment except that the lens material 7 of a solvent type is used, the description will be omitted.

Next, the waiting process (S24) will be described.

After the lens material 7 of 20 dots is ejected so as to form the micro lens precursor 8, the micro lens precursor 8 is allowed to stand for given time so as to be preliminarily hardened. If the micro lens precursor 8 is allowed to stand for given time, the solvent in the lens material 7 evaporates. Thus, the viscosity of the precursor increases such that the precursor becomes a preliminarily hardened state. As the given time to stand, a sufficient time is such that the lens material 7 has a viscosity that the micro lens precursor 8 does not crumble from the base member 4b with the collapse of the shape, even when the lens material 7 further lands on the micro lens precursor 8.

During the waiting process (S24), the lens material 7 may be allowed to stand with keeping (not moving) the relative positional relationship between the base member 4b and the droplet ejection head constant, or with ejecting the lens material 7 on other base member 4b.

In the case in which the relative positional relationship between the base member 4b and the droplet ejection head is kept constant during the waiting process (S24), the landing position of the lens material 7 in the next ejection process (S23) can be prevented from deviating from the landing position in the previous ejection process. Thus, micro lenses with good shape accuracy can be formed.

Alternatively, if the lens material 7 is ejected on other base member 4b during the waiting process (S24), the ejection process (S23) for the lens material 7 and the waiting process (S24) can be implemented in parallel such that the time required to form micro lenses can be shortened.

Returning to the ejection process (S23) again, when preliminary hardening of the micro lens precursor 8 is completed, the lens material 7 of 20 dots is ejected on the micro lens precursor 8 that has been preliminarily hardened. Thereafter, preliminary hardening in the waiting process (S24) is implemented. This cycle is repeated until the micro lens precursor 8 made up of a lens material of 100 dots is formed on the base member 4b (in the present exemplary embodiment, repeated 5 times).

In the above structure, the preliminary hardening is implemented by allowing the lens material 7 of a solvent type that has landed on the base member to stand for given time so as to increase the viscosity of the lens material 7. Therefore, there is no need to use a device for preliminarily hardening the lens material 7 such that the configuration of a device for manufacturing micro lenses can be simplified.

Here, it should be understood that the technical scope of the present invention is not limited to the above exemplary embodiments but apply to various kinds of modifications without departing from the scope and spirit of the present invention.

For example, a micro lens of an exemplary aspect of the present invention is applicable to, other than the above applications, various kinds of optical devices. For example, the micro lens can also be used as an optical part provided for a light receiving surface of a solid-state imaging device (CCD), an optical coupling part of an optical fiber, and so forth.

1. A method of manufacturing a micro lens in which a given number of droplets of a lens material are ejected from a droplet ejection head on a base member formed on a substrate, comprising:
stopping relative movement between the substrate and the droplet ejection head; and
sequentially ejecting a plurality of the droplets on a given position on the substrate from the droplet ejection head.

2. The method of manufacturing a micro lens according to claim 1, further including sequentially ejecting a number of droplets from the droplet ejection head at one time that is the same as the given number.

3. The method of manufacturing a micro lens according to claim 1, further including sequentially ejecting a number of droplets from the droplet ejection head at one time that is smaller than the given number, and
preliminarily hardening being implemented for lens material that has landed on the base member before a next ejection of the droplets to the same base member.

4. The method of manufacturing a micro lens according to claim 3, further including repeating ejection of the droplets to the same base member while the relative movement is stopped until a total number of the droplets ejected on the same base member becomes equal to the given number.

5. The method of manufacturing a micro lens according to claim 3, further including after the droplets are ejected on one base member, ejecting the droplets on at least one other base member, and then ejecting the droplets on the one base member again.

6. The method of manufacturing a micro lens according to claim 1,
the base member including a plurality of base members; and
the droplets being ejected on the plurality of base members at one time from the droplet ejection head.

7. The method of manufacturing a micro lens according to claim 3,
the lens material being a material diluted with a volatile solvent; and
the preliminary hardening being implemented by allowing the lens material that has landed to stand for a given time.

8. The method of manufacturing a micro lens according to claim 3,
the lens material being a material reacting to ultraviolet rays so as to be hardened; and
the preliminary hardening being implemented by irradiating the lens material that has landed with ultraviolet rays.

9. A micro lens manufactured through the method of manufacturing a micro lens according to claim 1.

10. An optical device, comprising:
a surface emitting laser; and
a micro lens obtained through the method of manufacturing a micro lens according to claim 1, the micro lens being provided on an emitting side of the surface emitting laser.

11. An optical transmitting device, comprising:
the optical device according to claim 10;
a light receiving element; and
an optical transmitting device that transmits light emitted from the optical device to the light receiving element.

12. A laser printer head comprising:
the optical device according to claim 10.

13. A laser printer, comprising:
the laser printer head according to claim 12.
